(19) United States
(12) Patent Application Publication
(10) Pub. No.: US 2009/0278823 A1
(43) Pub. Date: Nov. 12, 2009

(54) Image frame regulation system and image frame regulating method

(76) Inventors: Cheng-Yueh Kuo, Jiading Township (TW); Meng-Ta Yu, Changhua City (TW); Yu-Tang Chang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,864

(22) Filed: May 9, 2008

(51) Int. Cl. G09G 5/18

(52) U.S. Cl. 345/204

(57) ABSTRACT

An image frame regulation system includes a display module a timing controller and the timing converter. The timing controller is coupled to the display module. The timing controller outputs image data to the display module and outputs a timing control command. The timing control command includes a vertical sync signal, a horizontal sync signal and a pixel enabling signal. The timing converter is coupled between the timing controller and the display module to receive the timing control command and adjusts a period of the pixel enabling signal in the timing control command to output an adjustable timing control command to the display module, so as to control the display module to display an output image frame corresponding to the image data at a central area of a screen of the display module.

### BACKGROUND OF THE INVENTION

1. Field of the Invention

The invention generally relates to an image frame regulation system and an image frame regulating method, and particularly to an image frame regulation system and an image frame regulating method which displays image frame data at a central area of a screen of a display module.

2. Description of the Related Art

FIG. 1 is a schematic view of a conventional liquid crystal display. The liquid crystal display includes a display panel 200, displaying image frames, and a timing controller 100 controlling the display panel 200. FIG. 2 is a wave graph of timing of a conventional timing controller. The timing controller 100 generates image data LDD and a timing control command according to external data Data_In. The timing control command S1 includes a vertical synchronization (V-sync) signal, a horizontal synchronization (H-sync) signal, a data enabling signal OE and a clock CLK). The timing controller 100 sends out a vertical sync (V-sync) signal and a horizontal sync (H-sync) signal to respectively control the row driver 206 and the column driver 204. The data enabling signal OE and the image data LDD are sent to the display panel 200 to display an output image frame 202.

The timing controller 100 which uses ASIC cannot be applied to any type of display panel 200. Referring to FIG. 1 and FIG. 2, the timing control command S1 from the timing controller 100 is used to control the display panel 200 of 800×600 in size to display an output image frame 202 of 800×600 in pixels. When the same type of the timing controller 100 is to be applied to the display panel 300 of different size (856×600) as shown in FIG. 3, the same timing control command S1 cannot allow the image data LDD to be displayed at the central area of the screen of the display panel 300 of 856×600 in size, resulting in shifting, twisting or deforming the image frame instead. For example, the output image frame 202 is horizontally shifted by 56 pixels as shown in FIG. 3.

### SUMMARY OF THE INVENTION

It is an object of the invention to provide an image frame regulation system and an image frame regulating method, in which a period of data enabling signal from the timing controller can be regulated, and during the period of timing enabling a leading filler data and a trailing filler data are respectively put before and after a horizontal data or a vertical data so as to ensure the image frame is displayed at the central area of the display panel screen.

In order to aid understanding, it is necessary to explain in detail the exact relation between the leading filler data, the data (horizontal or vertical), and the trailing filler data. When the display panel is of regular size, the data (horizontal or vertical) would be perfectly positioned in the center, with no distortion. However, if the display panel is of irregular ratio, either particularly long or particular tall, then the data (horizontal or vertical) would be distorted to fill the screen. The present invention intends to insert “leading filler data” and “trailing filler data” to compensate for the extra display space and force the original data (horizontal or vertical) to be displayed in the middle and un-distorted as it was intended. For a particularly long display panel screen, “leading filler data” fills the extra space that occurs to the left of original data's display area, and “trailing filler data” fills the extra space that occurs to the right of original data's display area. For a particularly tall display panel screen, “leading filler data” fills the extra space that occurs to the top of original data's display area, and “trailing filler data” fills the extra space that occurs to the bottom of the original data's display area.

In order to achieve the above and other objectives, the image frame regulation system according to a first embodiment of the invention includes a display module, a timing controller and the timing converter. The timing controller is coupled to the display module. The timing controller outputs image data to the display module and outputs a timing control command, wherein the timing control command comprises a vertical sync signal, a horizontal sync signal and a pixel enabling signal. The timing converter is coupled between the timing controller and the display module to receive the timing control command and adjusts the period of the pixel enabling signal in the timing control command to output an adjustable timing control command to the display module, so as to control the display module to display an output image frame corresponding to the image data at a central area of a screen of the display module.

In the image frame regulation system according to a second embodiment of the invention, the timing controller puts a leading vertical filler data and a trailing vertical filler data before and after vertical data according to the size of the display panel to control the display module to display the image data at the central area of the display module.

Furthermore, the invention provides an image frame regulating method. In the second embodiment of the invention, the image frame regulating method includes providing a vertical sync signal and a horizontal sync signal for driving the display panel to display image data; putting a leading horizontal filler data before a horizontal data and a trailing horizontal filler data after the horizontal data according to the size of the display panel; and providing a pixel enabling signal between two continuous pulses of the horizontal sync signal to enable the horizontal data, leading horizontal filler data and trailing horizontal filler data. The pixel enabling signal controls the display module to display an output image frame corresponding to the image data at a central area of a screen of the display module.

The image frame regulating method according to the second embodiment of the invention includes providing a vertical sync signal and a horizontal sync signal for driving the display panel to display image data; putting leading vertical filler data before vertical data and trailing vertical filler data after the vertical data according to the size of the display panel; and providing a pixel enabling signal between two continuous pulses of the vertical sync signal to enable the vertical data, leading vertical filler data and trailing vertical filler data, wherein the pixel enabling signal controls the display module to display an output image frame corresponding to the image data at a central area of the display module.

In light of above, by means of regulating the period of data enabling signal from the timing controller, the leading filler data and trailing filler data are respectively put before and after horizontal data or vertical data of the image data so as to adjust the image frame to be displayed at the central area of the screen of the display panel. Therefore, the same type of the timing controller can be used for the display panel of different sizes while keeping the output image frame at the central area of the screen. Thereby, the prior shifting problem is solved.

To provide a further understanding of the invention, the following detailed description illustrates embodiments and examples of the invention, this detailed description being provided only for illustration of the invention.

### BRIEF DESCRIPTION OF THE DRAWINGS

FIG. 1 is a schematic view of a conventional liquid crystal display;

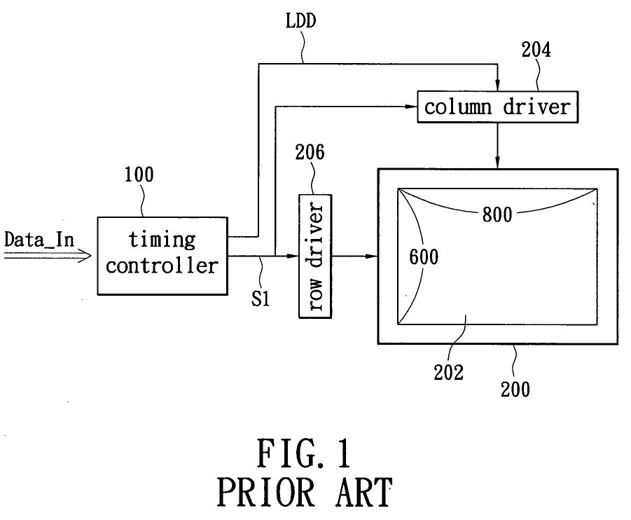

FIG. 2 is a wave graph of timing of a conventional timing controller;

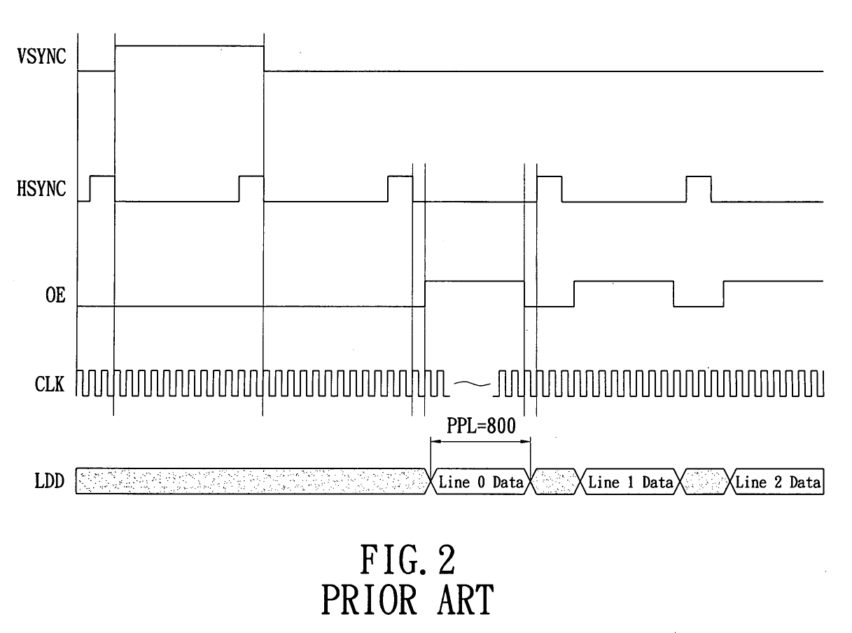

FIG. 3 is a schematic view of another conventional liquid crystal display;

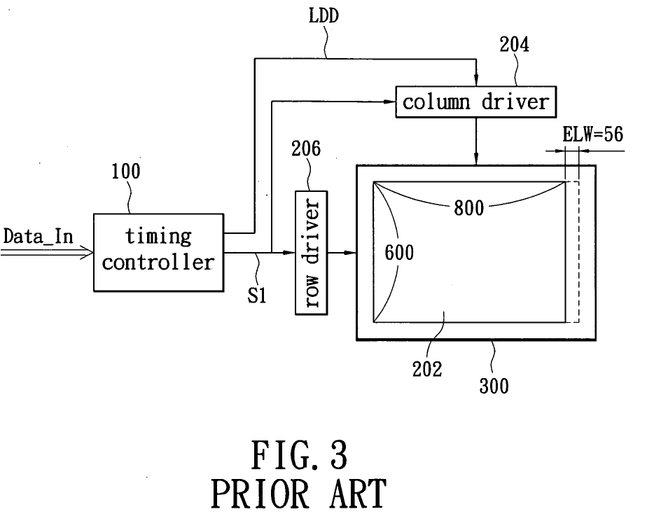

FIG. 4 is a schematic view of an image frame regulation system according to a first embodiment of the invention;

FIG. 5 is a wave graph of an adjustable timing control command S2 according to a first embodiment of the invention;

FIG. 6 is a flow chart of an image frame regulating method according to a first embodiment of the invention;

FIG. 7 is a schematic view of an image frame regulation system according to a second embodiment of the invention;

FIG. 8 is a wave graph of an adjustable timing control command S2′ according to a second embodiment of the invention; and

FIG. 9 is a flow chart of an image frame regulating method according to a second embodiment of the invention.

### DETAILED DESCRIPTION OF THE EMBODIMENTS

Wherever possible in the following description, like reference numerals will refer to like elements and parts unless otherwise illustrated.

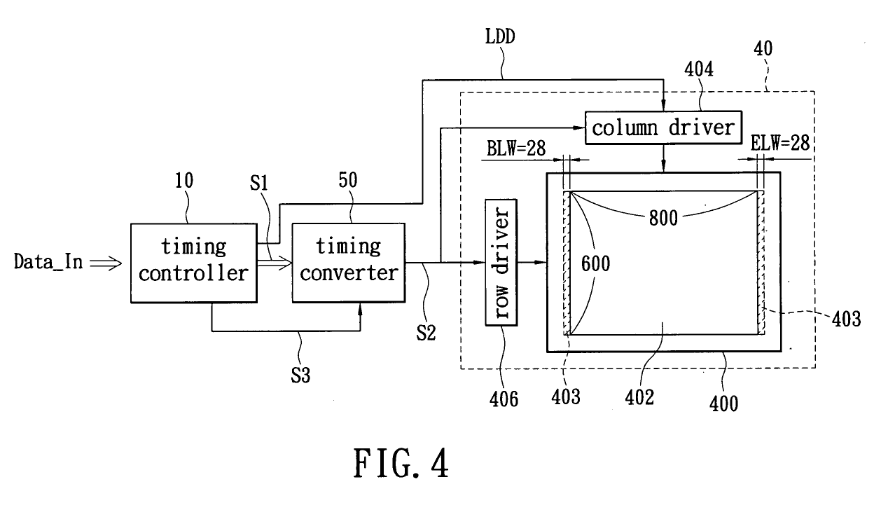

FIG. 4 is a schematic view of an image frame regulation system according to a first embodiment of the invention. The image frame regulation system includes a display module 40, a timing controller 10, and a timing converter 50.

The display module 40 includes a display panel 400, a row driver 406 and a column driver 404. The row driver 406 is coupled to the display panel 400 so as to drive data in rows of the display panel 400 to be displayed. The column driver 404 is coupled to the display panel 400 so as to drive data in columns of the display panel 400 to be displayed.

Referring to FIG. 4, the timing controller 10 is coupled to the display module 40 so as to output image data LDD to the display module 40 and output a timing control command S1. Furthermore, the timing converter 50 is coupled between the timing controller 10 and the display module 40. The timing converter 50 receives the timing control command S1 and adjusts a period of pixel enabling signals OE in the timing control command S1, to output an adjustable timing control command S2 to the display module 40. The adjustable timing control command S2 includes a vertical sync (V-sync) signal, a horizontal sync (H-sync) signal, a pixel enabling signal OE, and a clock CLK.

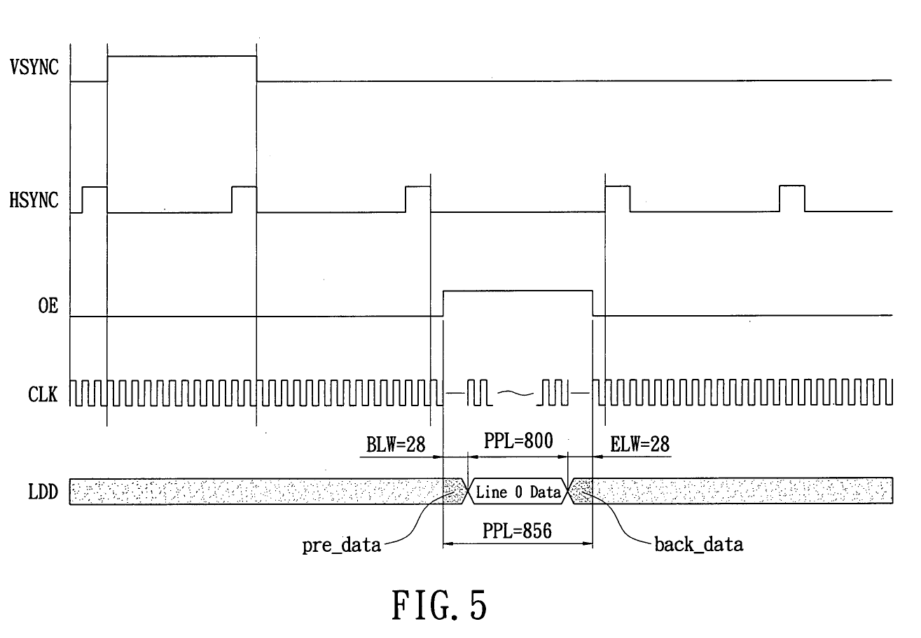

FIG. 5 is a wave graph of an adjustable timing control command S2 according to a first embodiment of the invention.

Referring to FIG. 4 and FIG. 5, the timing controller 10, according to the size of the display module, puts a leading horizontal filler data (pre_data) before a horizontal data 0 of the image data LDD, and puts a trailing horizontal filler data (back_data) after the horizontal data 0. The pixel enabling signal OE in the adjustable timing control command S2 is sent between two continuous pulses of the horizontal sync (H-sync) signal to enable the horizontal data 0, the leading horizontal filler data (pre_data) and the trailing horizontal filler data (back_data).

Referring to FIG. 4 and FIG. 5, the timing converter 50 controls the row driver 406 in the display module 40 by means of the vertical sync (V-sync) signal of the adjustable timing control command S2, and controls the column driver 404 in the display module 40 by means of horizontal sync (H-sync) signal of the adjustable timing control command S2. Thereby, the image data LDD is sent into the display module 40 and an output image frame 402 is displayed on the display panel 400 of the display module 40. Meanwhile, the timing converter 50 sends the image data LDD into the display module 40 by means of the pixel enabling signal OE of the adjustable timing control command S2, and displays the output image frame 402 at a central area of a screen of the display panel 400.

In a first embodiment of the invention, the timing controller 10 which outputs the image data LDD of 800×600 pixels is used together with the timing converter 50, so that the image data LDD of 800×600 pixels is sent into the display panel 300 of 856×600 in size. The display panel of 856×600 in size has over-wide length which has 56 pixels of horizontal distance from the image data LDD of 800×600 pixels. Therefore, the timing controller 10 puts 28 pixels of horizontal distance as leading horizontal filler data (pre_data) before horizontal data 0, and puts 28 pixels of horizontal distance as trailing horizontal filler data (back_data) after horizontal data 0, according to the 56 pixels of horizontal distance.

Meanwhile, the timing controller 10 outputs a notice signal S3 to the timing converter 50 to inform the timing converter 50 to adjust the period of the pixel enabling signal OE. Thereby, enabling of the horizontal data 0, the leading horizontal filler data (pre_data) and the trailing horizontal filler data (back_data) is achieved. The output image frame 402 corresponding to the image data LDD of 800×600 pixels is displayed on the central area of the screen of the display panel 400 of 856×600 in size. Furthermore, another image frame 403 corresponding to the pre_data and the back_data is displayed on either horizontal sides of the output image frame 402, with 28 pixels of horizontal distance at each side.

Therefore, the same type of the timing controller 10 can be used for the display panel 400 of different sizes, while keeping the image frame 402 displayed at the central area of the screen of the display panel 400, which improves the prior shifting problems.

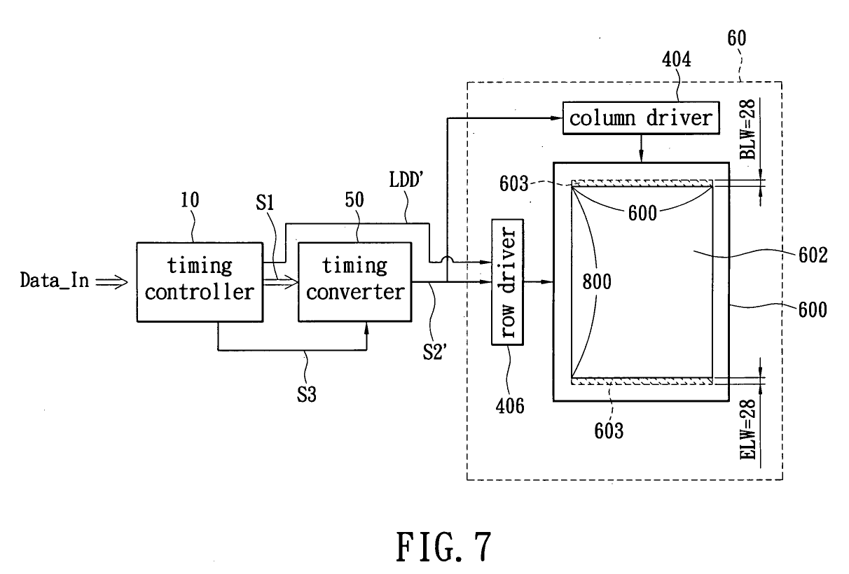

FIG. 7 is a schematic view of an image frame regulation system according to a second embodiment of the invention. The same reference numerals in the first embodiment and the second embodiment indicate the same device or element. The second embodiment is the same as the first embodiment, except the timing controller 10 in the second embodiment sends the image data LLD to the row driver 406 in the display module 60. The display module 60 has a display panel 600 of 600×856 in size.

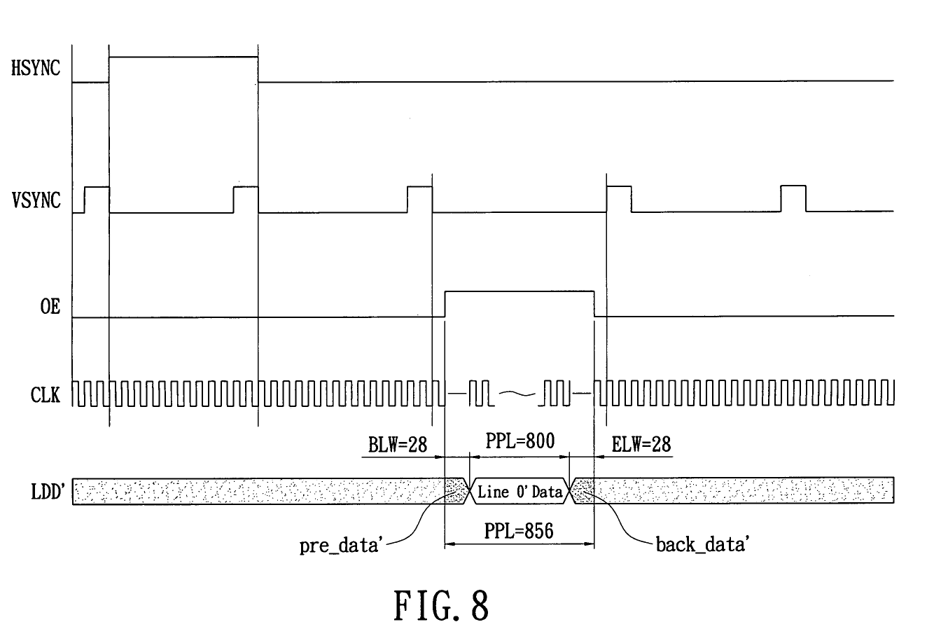

FIG. 8 is a wave graph of an adjustable timing control command S2′ according to a second embodiment of the invention. Referring to FIG. 7, the timing controller 10 puts a leading vertical filler data (pre_data) before a vertical data 0′ of the image data LDD, and puts a trailing vertical filler data (back_data) after the vertical data 0′. The pixel enabling signal OE in the adjustable timing control command S2′ is sent between two continuous pulses of the vertical sync (V-sync) signal to enable the vertical data 0′, pre_data and back_data.

Referring to FIG. 7 and FIG. 8, the timing converter 50 controls the row driver 406 in the display module 60 by means of the vertical sync (V-sync) signal of the adjustable timing control command S2′, and controls the column driver 404 in the display module 60 by means of the horizontal sync (H-sync) signal of the adjustable timing control command S2′. Thereby, the image data LDD is sent into the display module 60 and output image frame 602 is displayed on the display panel 600 of the display module 60. Meanwhile, the timing converter 50 sends the image data LDD into the display module 60 by means of the pixel enabling signal OE of the adjustable timing control command S2′, and displays the output image frame 602 at a central area of the screen of the display panel 600.

In the second embodiment, the timing controller 10 which outputs the image data LDD′ of 800×600 pixels is used together with the timing converter 50, so that the image data LDD′ of 800×600 pixels is sent into the display panel of 856×600 in size. The display panel of 856×600 in size has over-wide length which has 56 pixels of horizontal distance from the image data LDD′ of 800×600 pixels. Therefore, the timing controller 10 puts 28 pixels of vertical distance as leading vertical filler data (pre_data) before each vertical data 0, and puts 28 pixels of vertical distance as trailing vertical filler data (back_data) after each vertical data 0, according to the 56 pixels of vertical distance.

Meanwhile, the timing controller 10 outputs a notice signal S3 to the timing converter 50 to inform the timing converter 50 to adjust the period of the pixel enabling signal OE. Thereby, enabling of the vertical data 0, the leading vertical filler data (pre_data) and the trailing vertical filler data (back_data) is achieved. The output image frame 602 corresponding to the image data LDD′ of 800×600 pixels is displayed on the central area of the screen of the display panel 600 of 856×600 in size. Furthermore, another image frame 603 corresponding to the pre_data and the back_data is displayed on either horizontal sides of the output image frame 602, with 28 pixels of horizontal distance at each side.

Therefore, the same type of the timing controller 10 can be used for the display panel 600 of different sizes, while keeping the image frame 602 displayed at the central area of the screen of the display panel 600, which improves the prior shifting problems.

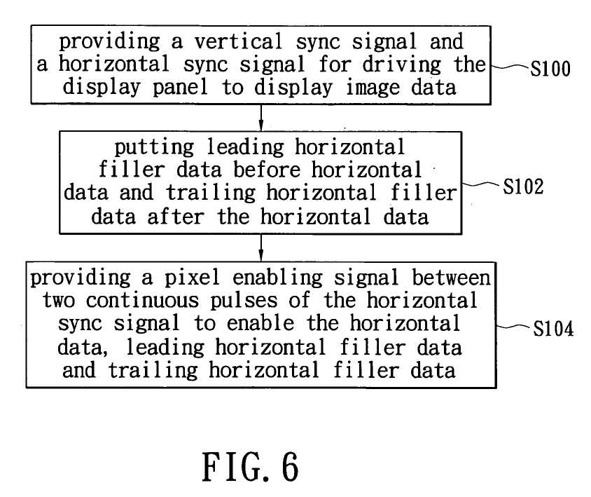

FIG. 6 is a flow chart of an image frame regulating method according to a first embodiment of the invention. With reference to FIG. 4 through FIG. 6, the image frame regulating method is executed in the image frame regulation system as shown in FIG. 4 and FIG. 5. The method includes providing a vertical sync (V-sync) signal and a horizontal sync (H-sync) signal for respectively controlling a row driver 406 and a column driver 404 to drive the display panel 400 to display an output image frame 402 corresponding to the image data LDD (S100). According to the size of the display panel 400, leading horizontal filler data (pre_data) is put before horizontal data 0 of the image data LDD, and trailing horizontal filler data (back_data) is put after the horizontal data 0 of the image data LDD (S102).

A pixel enabling signal OE is provided between two continuous pulses of the horizontal sync (H-sync) signal to enable the horizontal data 0, pre_data and back_data (S104). Thereby, the output image frame 402 corresponding to the image data LDD can be displayed at the central area of the screen of the display panel 400. The pixel enabling signal OE is proportional to the size of the display panel 400. At step S104, the image frame 403 corresponding to the horizontal pre-data and the back_data is displayed at either sides of the output image frame 402.

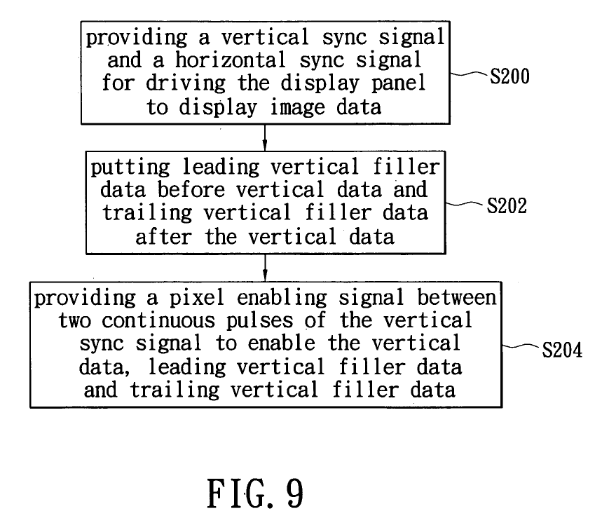

FIG. 9 is a flow chart of an image frame regulating method according to a second embodiment of the invention. Referring to FIG. 7 through FIG. 9, the image frame regulating method according to a second embodiment includes providing a vertical sync (V-sync) signal and a horizontal sync (H-sync) signal for respectively controlling a row driver 406 and a column driver 404 to drive the display panel 600 to display an output image frame 602 corresponding to the image data LDD (S200). According to the size of the display panel 600, leading vertical filler data (pre_data) is put before vertical data 0′ of the image data LDD, and trailing vertical filler data (back_data) is put after the vertical data 0′ (S202). A pixel enabling signal OE is provided between two continuous pulses of the vertical sync (V-sync) signal to enable the vertical data 0, pre_data and back_data (S204). Thereby, the output image frame 602 corresponding to the image data LDD can be displayed at the central area of the screen of the display panel 600. The pixel enabling signal OE is proportional to the size of the display panel 600. At step S204, the image frame 603 corresponding to the vertical virtual pre-data and the vertical virtual back_data is displayed at either sides of the output image frame 602.

In light of the above, the period of the data enabling signal from the timing controller can be adjusted. Furthermore, the leading filler data and trailing filler data are put before and after vertical or horizontal data so as to adjust the output image frame to be displayed on the central area of the screen of any-sized display panel. Therefore, the same type of timing controller can be used for the display panels of different sizes to display the output image frame on the central area of the screen of the display panel, overcoming the prior shifting problem.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A microarray system, comprising:
a microarray formed on a planar substrate; and
an incubation chamber formed around said microarray,
wherein said incubation chamber comprises a plurality of interior surfaces including a bottom surface on which said microarray is formed and a top surface that faces said microarray, and
wherein at least one of said a plurality of interior surfaces is a hydrophilic surface.

2. The microarray system of claim 1, wherein said hydrophilic surface is said top surface.

3. The microarray system of claim 2, wherein said hydrophilic surface is formed by covering said top surface with a hydrophilic coating.

4. The microarray system of claim 2, wherein said incubation chamber is formed by placing a gasket around said microarray and covering said gasket with a hydrophilic tape or a hydrophilic film.

5. The microarray system of claim 4, wherein said hydrophilic tape or hydrophilic film is transparent.

6. The microarray system of claim 1, further comprising a cover slip that covers said planar substrate, wherein said microarray is formed in a recession area on said planar substrate and wherein said incubation chamber is formed between said cover slip and said recession area on said planar substrate.

7. The microarray system of claim 1, further comprising a cover slip that covers said planar substrate, wherein said cover slip has a recession area, said recession area is larger than said microarray and is positioned on top of said microarray, and wherein said incubation chamber is formed between said microarray and said recession area on said cover slip.

8. The microarray system of claim 1, wherein said hydrophilic surface comprises impregnated chemicals that lyses cell membranes.

9. The microarray system of claim 8, wherein said hydrophilic surface comprises a hydrophilic matrix that retains nucleic acid from lysed cells.

10. The microarray system of claim 8, wherein said hydrophilic surface is said top surface.

11. The microarray system of claim 8, wherein said hydrophilic surface is said bottom surface.

12. The microarray system of claim 1, wherein said hydrophilic surface is said bottom surface.

13. The microarray system of claim 1, further comprising a one-way valve for loading a liquid sample into said incubation chamber.

14. The microarray system of claim 13, wherein said one-way valve is a check valve.

15. The microarray system of claim 13, wherein said one-way valve is a dome valve.

16. The microarray system of claim 13, wherein said one-way valve is connected to said incubation chamber through a first channel.

17. The microarray system of claim 1, further comprising a waste chamber.

18. The microarray system of claim 17, wherein said waste chamber comprises an absorbent capable of wicking liquid from said incubation chamber.

19. The microarray system of claim 18, wherein said absorbent comprises cellulose.

20. The microarray system of claim 17, wherein said waste chamber has a volume that is larger than a volume of said incubation chamber.

21. The microarray system of claim 17, wherein said waste chamber is connected to said incubation chamber through a second channel.

22. The microarray system of claim 21, wherein said waste chamber comprises an absorbent placed at a distance from said second channel to control wicking rate.

23. The microarray system of claim 21, wherein said second channel comprises an inlet section, a funnel shape connecting section, and an outlet section, wherein said inlet section has a diameter that is larger than a diameter of said outlet section.

24. The microarray system of claim 17, wherein said waste chamber is vented to atmosphere through a venting channel.

25. The microarray system of claim 1, wherein said substrate is glass.

26. The microarray system of claim 1, wherein said substrate is plastic.

27. The microarray system of claim 1, wherein said microarray is an oligonucleotide array.

28. The microarray system of claim 1, wherein said microarray is a protein array.

29. The microarray system of claim 28, wherein said protein array is an antibody array.

30. The microarray system of claim 1, wherein said microarray is formed by a gel spot printing method.

31. A microarray system, comprising:
a microarray formed on a planar substrate;
an incubation chamber, wherein said incubation chamber surrounds said microarray;
a dome valve for loading a liquid sample into said incubation chamber; and
a channel connecting said one-way valve to said incubation chamber.

32. A microarray system, comprising:
a microarray formed on a planar substrate;
an incubation chamber, wherein said incubation chamber surrounds said microarray;
a waste chamber containing an absorbent; and
a channel connecting said waste chamber to said incubation chamber.

33. The microarray system of claim 32, wherein said incubation chamber comprises an hydrophilic interior surface.
